(19) United States
(12) Patent Application Publication
(10) Pub. No.: US 2003/0140763 A1
(43) Pub. Date: Jul. 31, 2003

(54) FINISH PROTECTION DEVICE FOR STRINGED MUSICAL INSTRUMENTS

(76) Inventor: Michael John Casamento, East Setauket, NY (US)

Correspondence Address: MICHAEL J. CASAMENTO, 187 ERIK DRIVE, EAST SETAUKET, NY, 11733, US

(21) Appl. No.: 09/834,263

(22) Filed: Apr. 12, 2001

(51) Int. Cl. G10D 3/00

(52) U.S. Cl. 84/290

(57) ABSTRACT

A device for protecting the finish applied to the wood and other component parts of stringed musical instruments is provided, consisting of a device made from static-cling vinyl or a material of similar properties. The device is readily shaped and sized to conform to the area requiring protection. Once attached, the device forms a second skin over the finish thereby preventing damage from abrasion, skin oils, and perspiration. The device will not alter the original appearance, feel, or tonal qualities of the instrument, and may be repeatedly attached and removed without damage to the instrument's finish, or degradation in its adhesive qualities.

### BACKGROUND OF THE INVENTION

This invention relates to providing an effective means of protecting the finish applied to the wood and various component parts of stringed musical instruments.

The many finishes applied to a stringed musical instrument not only contribute to its beauty, but serves to protect the delicate elements out of which the instrument is constructed. Metal parts are often plated with such elements as chrome, nickel or even gold, while wooden areas are painstakingly finished with paint, stain, lacquer, and varnish. Over time, the finish applied to these elements will undoubtedly be exposed to the detrimental effects of abrasion, skin oils, and perspiration.

The very nature of playing a stringed instrument often necessitates repetitive movements across the finished surfaces subjecting them to abrasive damage. Articles of clothing worn by the player such as buttons, belt buckles, and jewelry also possess the propensity to cause damage to the finish. In addition, certain areas of the instrument may come into frequent contact with the skin of the player, exposing them to harmful elements such as skin oil, and perspiration.

Previous inventions in this field have been targeted primarily towards protecting the finish of the wood, and often consist of some type of padding or fabric cover that is affixed to the surface of the instrument over the area of concern.

U.S. Pat. No. 5,103,709 to Richard Foss Jr. describes a device consisting of a pliable fabric pad attached to a rigid sub-layer. This assembly is then attached to the instrument by means of Velcro fasteners. This device will conceal the finish and thereby alter the appearance of the instrument. In addition, fastening devices must be attached to the finish, which will remain in place even when the device is removed. The padding may also alter the tonal quality of the instrument.

U.S. Pat. No. 4,601,391, issued to Gibbs et al is another form of a fabric-based protector. The Gibbs et al device is designed to protect only the rear of the instrument. It must be constructed to fit the shape of the instrument, which makes it difficult to accommodate the large variation in the styles and shapes of musical instruments. It will greatly alter the appearance of the instrument, and since it is made from a flexible fabric, friction can occur as the device moves over the surface of the instrument thereby promoting wear.

U.S. Pat. No. 4,084,477 to Richard Lee Dominguez describes a device designed to standoff from the surface of the instrument thereby preventing dust and debris from accumulating between the finish and the device. Hook and loop fasteners are used to attach the device to the surface of the instrument. The design of this device may help to reduce any adverse affects on tonal quality, as well as the abrasive affects of debris caught between the device and the instrument, however, the feel and looks of the instrument would be greatly altered. In addition, fastening devices must be attached to the finish, which will remain in place even after the device is removed.

All of these referenced devices are primarily designed to protect the wood finish on the rear surface of the instrument. The bulkiness of their construction and attachment methods tends to prohibit them from being a practical solution for protecting other areas of the instrument or component parts, such as but not limited to, the pick guard, tailpiece, and bridge. It is also difficult to size and shape these devices to conform to the varied contours of different instruments.

### BRIEF SUMMARY OF THE INVENTION

This invention relates to a device constructed from static-cling vinyl, or a material of similar properties, which is designed to prevent damage to the finished surfaces of the wood and other component parts of certain stringed musical instruments.

One feature of the invention briefly stated is, a device comprising a sheet of static-cling vinyl, or a material of similar properties, which conforms, or can be readily made to conform, to the size and shape of the surface being protected. Once applied, the device will form a second skin to the finish, thereby protecting the finish from exposure to abrasion, skin oils, and perspiration.

The properties of the material enable the device to adhere to any smooth nonporous surface without the use of fasteners or adhesives that can harm the finish, or alter the appearance of the instrument. The properties of the material would further enable the device to be repeatedly removed and applied without damage to the finish, or degradation to the adhesive qualities of the device.

The device is designed to completely adhere to the surface forming a second skin with virtually no gaps between which dust and debris can become trapped. In addition, the propensity for the device to move about over the finish contributing to abrasive wear is completely eliminated.

The material from which the device is constructed is readily available in either clear or solid colorations. The translucent qualities of the clear material would allow the beauty of the underlying finish to be visible, providing protection to the concerned area without altering the appearance of the instrument. The solid colorations can be utilized to facilitate the concealment of finish imperfections on older instruments while preventing further damage.

The material is inherently very thin, (only several mils in thickness), and is extremely light in weight. As a result, the playability of the instrument with respect to its original feel and tonal qualities will not be altered or affected in any way.

### DESCRIPTION OF THE DRAWING FIGURES

FIG. 1—Depicts the device applied to the rear surface of an acoustic guitar.

### LIST OF REFERENCE NUMERALS USED IN THE DRAWINGS

1—a stringed musical instrument

2—the device element

### DETAILED DESCRIPTION OF THE INVENTION

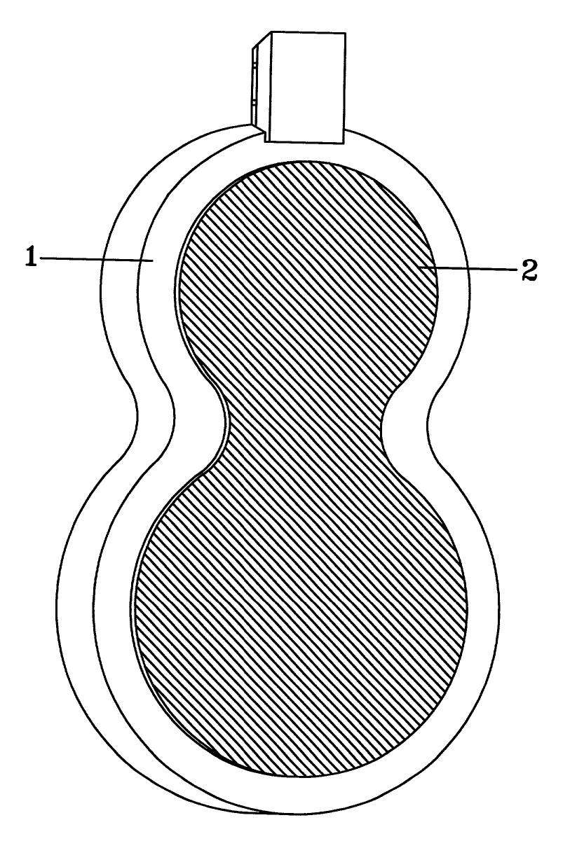

Referring to FIG. 1, the depicted stringed musical instrument 1 shows the rear surface of an acoustic guitar. In its preferred embodiment, the invention consists of a device element 2 fabricated from static-cling vinyl or a material of similar properties. This material has been widely used by decal and label suppliers to provide a product which adheres to smooth non-porous surfaces, and which can be easily removed without damaging the label, or leaving behind any adhesive residue. The device element 2 is made to conform to the shape and size of the protected area, after which it is aligned, and placed in contact with the surface of the stringed musical instrument 1. Pressure is applied to the surface of the device element 2 to promote the bond, and remove any pockets of trapped air. Once applied, the device element 2 will remain in position with virtually no movement, or gaps between the finish and the device element 2. Removal of the device element 2 is facilitated by lifting the device element 2 at one edge, and pulling in a direction away from the surface of the stringed musical instrument 1.

Although the above description includes much specificity, this should not be construed as limitations on the scope of the invention, but as merely providing an illustration of the preferred embodiment. Thus, the scope of the invention should be determined by the appended claims and their legal equivalents, rather than by the examples given.

I claim:

1. A device for protecting the finish of stringed musical instruments and their component parts, wherein said device is suitably sized and constructed of static-cling vinyl, or a material of similar properties.
